(19) United States
(12) Patent Application Publication
(10) Pub. No.: US 2019/0180699 A1
(43) Pub. Date: Jun. 13, 2019

(54) DISPLAY DEVICE AND METHOD FOR CONTROLLING THE SAME

(71) Applicant: SHARP KABUSHIKI KAISHA, Sakai City (JP)

(72) Inventors: FUMITAKA SEKI, Sakai City (JP); KENJI MAEDA, Sakai City (JP)

(21) Appl. No.: 16/207,468

(22) Filed: Dec. 3, 2018

(30) Foreign Application Priority Data
Dec. 7, 2017 (JP) 2017-235466

(51) Int. Cl. G09G 3/34; G09G 3/36

(52) U.S. Cl. CPC G09G 3/342; G09G 2320/064; G09G 3/36

(57) ABSTRACT

A display device includes a display control section configured to control an LCD and a backlight. The display control section causes the backlight to illuminate, during a time period in which an optical transmittance of the LCD is being changed, in an illumination pattern having N (N is an integer of two or more) light emission intensity levels that range from a first level to an Nth level.

This Non provisional application claims priority under 35 U.S.C. § 119 on Patent Application No. 2017-235466 filed in Japan on Dec. 7, 2017, the entire contents of which are hereby incorporated by reference.

### TECHNICAL FIELD

An aspect of the present invention relates to a display device including a liquid crystal panel and a backlight.

BACKGROUND ART

In recent years, various proposals have been made for methods for controlling (driving) display devices (liquid crystal display devices) each including a liquid crystal panel and a backlight. For example, Patent Literature 1 discloses a driving method in which a black data insertion mode is used. A technique of Patent Literature 1 has an object to, for example, improve an apparent response speed of a liquid crystal panel.

### CITATION LIST

### Patent Literature

[Patent Literature 1]

Japanese Patent Application Publication Tokukai No. 2007-179027

### SUMMARY OF INVENTION

### Technical Problem

An aspect of the present invention has an object to more effectively improve an apparent response speed of a liquid crystal panel than a conventional technique.

### Solution to Problem

In order to attain the object, a display device in accordance with an aspect of the present invention includes: a liquid crystal panel; a backlight; and a control device configured to control the liquid crystal panel and the backlight, the control device causing the backlight to illuminate, during a time period in which an optical transmittance of the liquid crystal panel is being changed, in an illumination pattern having N (N is an integer of two or more) light emission intensity levels that range from a first level to an Nth level.

Further, in order to attain the object, a method in accordance with an aspect of the present invention for controlling a display device including a liquid crystal panel and a backlight, the method includes: a control step of controlling the liquid crystal panel and the backlight, the control step further including an illumination control step of causing the backlight to illuminate, during a time period in which an optical transmittance of the liquid crystal panel is being changed, in an illumination pattern having N (N is an integer of two or more) light emission intensity levels that range from a first level to an Nth level.

### Advantageous Effects of Invention

A display device in accordance with an aspect of the present invention makes it possible to more effectively improve an apparent response speed of a liquid crystal panel than a conventional technique. Further, a method for controlling a display device in accordance with an aspect of the present invention also brings about an effect similar to that brought about by the display device in accordance with an aspect of the present invention.

### BRIEF DESCRIPTION OF DRAWINGS

FIG. 1 is a functional block diagram illustrating a configuration of a main part of a display device in accordance with Embodiment 1.

FIG. 2 is a view for explaining an example of how a light source control signal is generated in the display device of FIG. 1.

FIG. 3 illustrates a flow of a process for setting a BL illumination pattern in the display device of FIG. 1.

FIG. 4 is a view for explaining Comparative Example 1.

FIG. 5 is a view for explaining Comparative Example 2.

FIG. 6 is a view for explaining Comparative Example 3.

FIG. 7 is a view for explaining a first example of a QS flash backlight mode.

FIG. 8 is a view for explaining a second example of the QS flash backlight mode.

FIG. 9 is a functional block diagram illustrating a configuration of a main part of a display device in accordance with a Variation of Embodiment 1.

FIG. 10 is a view for explaining a third example of the QS flash backlight mode.

FIG. 11 is a view for explaining a fourth example of the QS flash backlight mode.

FIG. 12 is a functional block diagram illustrating a configuration of a main part of a display device in accordance with Embodiment 4.

FIG. 13 is a view for explaining a fifth example of the QS flash backlight mode.

FIG. 14 is a view for explaining a sixth example of the QS flash backlight mode.

### DESCRIPTION OF EMBODIMENTS

### Embodiment 1

The following description discusses Embodiment 1. Note that, for convenience, members having functions identical to those of the respective members described in Embodiment 1 are given respective identical reference signs, and a description of those members will be omitted in later embodiments.

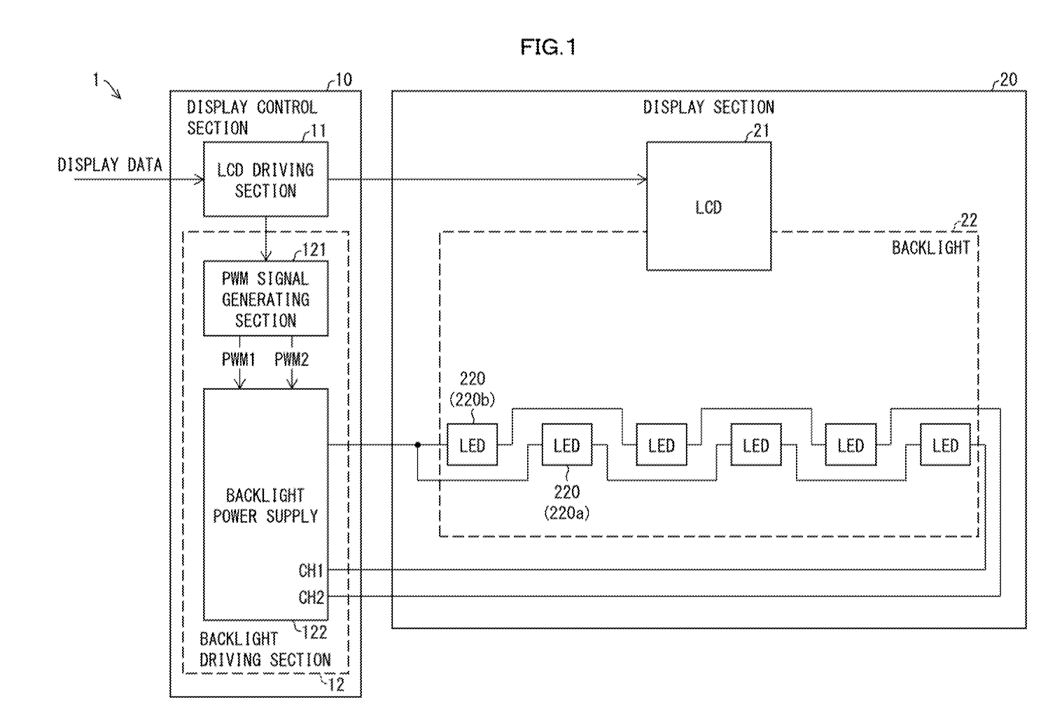

FIG. 1 is a functional block diagram illustrating a configuration of a main part of a display device 1 of Embodiment 1. The display device 1 includes a display control section 10 (control device) and a display section 20. FIG. 1 illustrates the display device 1 which includes one (i.e., a single) display control section 10 and one (i.e., a single) display section 20. Note, however, that at least either the number of display control sections 10 or the number of the display section 20 is two or more.

The display device 1 can be a portable display device. For example, the display device 1 can be a smartphone. Alternatively, the display device 1 can be a head mounted display (HMD) or any of other wearable devices. The display device 1 can alternatively be a stationary display device (e.g., a television or a desktop personal computer (PC)).

The display section 20 includes a liquid crystal display (LCD) 21 (liquid crystal panel) and a backlight (BL) 22. In view of this, the display device 1 can be referred to as a liquid crystal display device. The LCD 21 has a vertical direction (upward/downward direction) and a horizontal direction (transverse direction) which are defined in advance. The LCD 21 includes a plurality of pixels (display elements) which are provided in the vertical direction and in the horizontal direction. Specifically, the LCD 21 includes a plurality of pixels which is provided in a matrix pattern. The LCD 21 includes a liquid crystal layer (not illustrated). The LCD 21 can further include a color filter (not illustrated).

The backlight 22 emits light (e.g., white light) to the LCD 21. The backlight 22 is provided so as to face a back surface of the LCD 21 (a surface of the LCD 21 which surface is opposite from a display surface of the LCD 21) and overlap the LCD 21. Note that, for convenience, FIG. 1 less accurately illustrates how the LCD 21 and the backlight 22 overlap each other.

The backlight 22 includes a plurality of light emitting diodes (LEDs) 220 serving as a light source. The backlight 22 can include a diffusion sheet (not illustrated) for diffusing light emitted from the plurality of LEDs 220. By controlling a light emission intensity (e.g., a luminance) of each of the plurality of LEDs 220, it is possible to control a light emission intensity of a light emitting surface (a surface which faces the back surface of the LCD 21) of the backlight 22. That is, it is possible to control a light emitting state (illumination state) of the backlight 22. Light which is emitted from the plurality of LEDs 220 of the backlight 22 to the LCD 21 allows a plurality of pixels to form an image in a display surface (display area) of the LCD 21. That is, it is possible to display a desired image (display image (described later)) in the display area.

According to the example of FIG. 1, six LEDs 220 are provided near a lower edge of the backlight 22. Note, however, that the number and location of LEDs 220 are not limited to those of the example of FIG. 1. The number and location of LEDs 220 only need to be set so that the light emission intensity of the entire light emitting surface of the backlight 22 can be adjusted. More specifically, the number and location of LEDs 220 only need to be set so that the light emitting surface of the backlight 22 can uniformly illuminate. The “light emitting surface of the backlight 22” is hereinafter also merely referred to as the “backlight 22”.

(i) Some of the plurality of LEDs 220 are connected to a CH 1 (first channel) of a backlight power supply 122 (described later), and (ii) the others of the plurality of LEDs 220 are connected to a CH 2 (second channel) the backlight power supply 122.

The LEDs 220 which are connected to the CH 1 are hereinafter referred to as LEDs 220a (a first light source group). Meanwhile, the LEDs 220 which are connected to the CH 2 are referred to as LEDs 220b (a second light source group). According to the example of FIG. 1, three LEDs 220a and three LEDs 220b are provided. Note, however, that neither the number of LEDs 220a nor the number of LEDs 220b is limited to three.

For example, the number of LEDs 220a and the number of LEDs 220b each can be less than three or more than three. Alternatively, the number of LEDs 220a and the number of LEDs 220b can be different from each other.

As illustrated in FIG. 1, a group of LEDs 220a and a group of LEDs 220b are each connected in parallel with the backlight power supply 122. Hence, the group of LEDs 220a and the group of LEDs 220b can be driven (subjected to turning-on/off control) independently of each other.

The group of LEDs 220a and the group of LEDs 220b are provided so as to separately allow the backlight 22 to uniformly illuminate. For example, as illustrated in FIG. 1, the LEDs 220a and the LEDs 220b are provided so that an LED 220a and an LED 220b are adjacent to each other. The LEDs 220a and the LEDs 220b are thus provided near the lower edge of the backlight 22 so that the LEDs 220a alternate with the LEDs 220b.

The above configuration allows the backlight 22 to uniformly illuminate in a case where the LEDs 220a are driven (turned on) and the LEDs 220b are stopped (turned off). The above configuration also allows the backlight 22 to uniformly illuminate in a case where the LEDs 220a are stopped and the LEDs 220b are driven.

The display control section 10 controls (drives) sections (the LCD 21 and the backlight 22) of the display section 20. The display control section 10 includes an LCD driving section 11 (liquid crystal panel driving section) and a backlight driving section 12. The LCD driving section 11 receives data (display data) on an image to be displayed by the display section 20. An image to be displayed based on the display data is hereinafter also referred to as a display image. The display image can be, for example, each frame image that forms a moving image.

The LCD driving section 11 drives the LCD 21. The LCD driving section 11 generates an LCD control signal (liquid crystal panel control signal) in accordance with the display data. The LCD control signal is a signal (e.g., a voltage signal) for controlling a display timing of the LCD 21. According to Embodiment 1, the LCD control signal is a vertical synchronization signal (VSYNC).

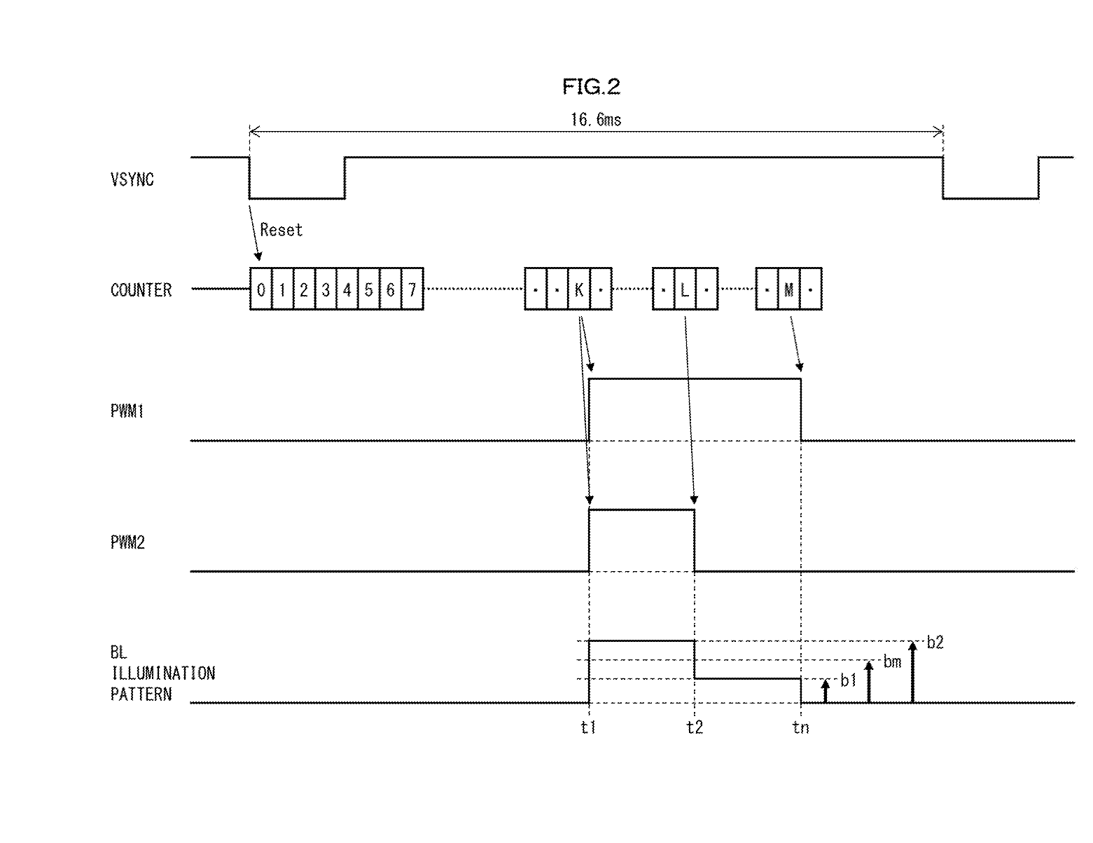

The LCD driving section 11 supplies the VSYNC to the LCD 21. The LCD driving section 11 also supplies the VSYNC to the backlight driving section 12 (more specifically, a pulse width modulation (PWM) signal generating section 121 (described later)). Embodiment 1 assumes that the LCD 21 is driven at a refresh rate of 60 Hz. Thus, a cycle of the VSYNC is 1/60 Hz (≈16.6 milliseconds (ms)) (see, for example, FIG. 2 (described later)). In this case, the LCD 21 can favorably display a moving image whose frame rate is 60 frames per second (fps).

The LCD driving section 11 further generates an LCD driving signal (liquid crystal panel drive signal) in accordance with the display data. The LCD driving signal is a signal (e.g., a voltage signal) for controlling an optical transmittance of each pixel of the LCD 21 (more specifically, an optical transmittance obtained at a position in the liquid crystal layer which position corresponds to the each pixel). By supplying the LCD driving signal to the LCD 21, the LCD driving section 11 allows the LCD 21 to display the display image.

LCD driving signals are applied in order from the first pixel (e.g., a pixel at the highest left) to the last pixel (e.g., a pixel at the lowest right) of the LCD 21 in one cycle of the VSYNC. Note that, for convenience, Embodiment 1 refers to a process, in which the LCD driving section 11 supplies the LCD driving signals to the LCD 21, as “LCD driving” (driving of the LCD 21).

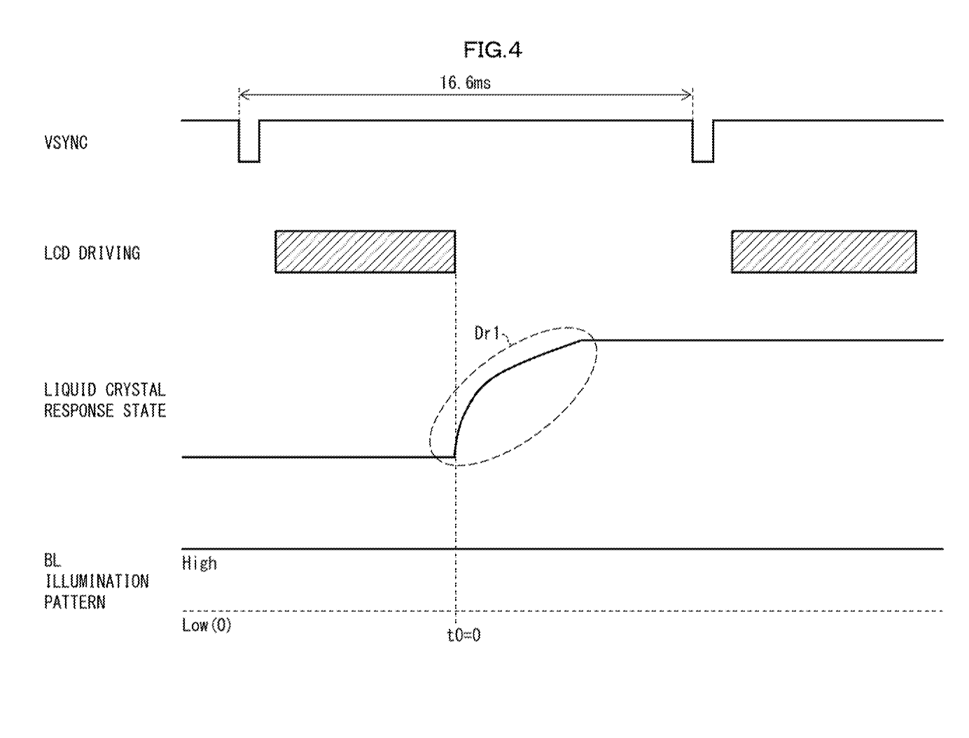

A timing at which to start the “LCD driving” indicated by a legend “LCD DRIVING” in the following figures (e.g., FIG. 4) corresponds to a timing at which the LCD driving signal is applied to the first pixel of the LCD 21. Meanwhile, a timing at which to terminate the “LCD driving” corresponds to a timing at which the LCD driving signal is applied to the last pixel of the LCD 21.

The backlight driving section 12 drives the backlight 22 (more specifically, the LEDs 220). The backlight driving section 12 includes the PWM signal generating section 121 and the backlight power supply 122.

The PWM signal generating section 121 generates a light source control signal in accordance with the VSYNC (liquid crystal panel control signal). The light source control signal is a signal (e.g., an electric current signal) that the backlight driving section 12 uses to control (drive) the LEDs 220. The light source control signal can be understood to be a signal for driving the backlight 22. Thus, the light source control signal can also be referred to as a backlight control signal (BL control signal).

The light source control signal allows the backlight 22 to emit light at a plurality of (N) luminance levels (light emission intensity levels) where N is an integer of two or more. For example, the description of Embodiment 1 takes, as an example, a case where the backlight 22 emits light at two luminance levels, which are a first luminance level (hereinafter denoted by b1) and a second luminance level (hereinafter denoted by b2). Note that the following description discusses a BL illumination pattern assuming that the plurality of luminance levels includes no luminance level that corresponds to a luminance of 0 (an off state).

The PWM signal generating section 121 generates a PWM 1 (first PWM signal) and a PWM 2 (second PWM signal) in accordance with the VSYNC. In Embodiment 1, the PWM 1 and the PWM 2 are each used as the light source control signal. The PWM 1 is a signal for controlling light emission by the LEDs 220a (first light source group). The PWM 2 is a signal for controlling light emission by the LEDs 220b (second light source group). The PWM 1 and the PWM 2 allow the backlight 22 to emit light at two luminance levels.

### Example of How to Set BL Illumination Pattern

FIG. 2 is a view (timing chart) for explaining an example of how the PWM signal generating section 121 generates light source control signals (PWM 1 and PWM 2). The following description discusses, with reference to FIG. 2, an example of how to set a BL illumination pattern. According to the example of FIG. 2, the PWM 1 and the PWM 2 are each assumed to be a binary signal (e.g., 1-bit digital signal). The following description assumes that the PWM 1 and the PWM 2 can each have either of two values, which are a Low value (e.g., 0) and a High value (e.g., 1).

The backlight power supply 122 drives the LEDs 220 (the LEDs 220a and the LEDs 220b). The backlight power supply 122 supplies the PWM 1 to the LEDs 220a via the CH 1. The backlight power supply 122 drives the LEDs 220a in accordance with the PWM 1. Specifically, the backlight power supply 122 turns off the LEDs 220a in a case where the PWM 1 has a Low value. In contrast, the backlight power supply 122 turns on the LEDs 220a in a case where the PWM 1 has a High value.

Similarly, the backlight power supply 122 supplies the PWM 2 to the LEDs 220b via the CH 2. The backlight power supply 122 drives the LEDs 220b in accordance with the PWM 2. Specifically, the backlight power supply 122 turns off the LEDs 220b in a case where the PWM 2 has a Low value. Meanwhile, the backlight power supply 122 turns on the LEDs 220b in a case where the PWM 2 has a High value.

The PWM signal generating section 121 includes a counter (COUNTER) (not illustrated) which increments (counts up) a count value by 1 every predetermined cycle. A cycle in which to count up the count value is sufficiently shorter than the cycle of the VSYNC (16.6 ms). Note that the count value is reset to zero at a point in time at which the VSYNC switches from High to Low (at the beginning of one frame period). That is, the count value is reset to zero every cycle of the VSYNC.

The PWM 1 and the PWM 2 are each set to a Low value (e.g., 0) at a point in time at which the count value is reset to zero. According to the example of FIG. 2, a time at which the count value is reset to 0 is set as 0 (a reference time) for convenience. The PWM signal generating section 121 causes each of the PWM 1 and the PWM 2 to switch from Low to High when the count value reaches K (a predetermined natural number). According to the example of FIG. 2, a time at which the count value reaches K is indicated by t1.

Subsequently, the PWM signal generating section 121 causes the PWM 2 to switch from High to Low when the count value reaches L (a predetermined natural number larger than K). From then on, the PWM signal generating section 121 maintains the PWM 2 at a Low value. According to the example of FIG. 2, a time at which the count value reaches L is indicated by t2.

Meanwhile, the PWM signal generating section 121 maintains the PWM 1 at a High value until the count value reaches M (a predetermined natural number larger than L). According to the example of FIG. 2, a time at which the count value reaches M is indicated by tn. The PWM signal generating section 121 causes the PWM 1 to switch from High to Low when the count value reaches M. From then on, the PWM signal generating section 121 maintains the PWM 1 at a Low value.

Thus, according to the example of FIG. 2, values of each of the PWM 1 and the PWM 2 are set in the cycle of the VSYNC as below assuming that a time is t.
In a case where 0≤t<t1 (during a time period before the start of illumination), the PWM 1 has a Low value and the PWM 2 has a Low value.
In a case where t1≤t<t2 (during a first illumination time period), the PWM 1 has a High value and the PWM 2 has a High value.
In a case where t2≤t<tn (during a second illumination time period), the PWM 1 has a High value and the PWM 2 has a Low value.
In a case where tn≤t≤16.6 ms (during a time period from the end of illumination), the PWM 1 has a Low value and the PWM 2 has a Low value.

Note that the first illumination time period and the second illumination time period are collectively referred to as a BL illumination period. Note also that the time t1 is a point in time at which the BL illumination period starts, and the time tn is a point in time at which the BL illumination period ends.

As illustrated in a legend “BL ILLUMINATION PATTERN” of FIG. 2, both the LEDs 220a and the LEDs 220b are off during each of the time period before the start of illumination and the time period from the end of illumination. This causes the backlight 22 to have a luminance of 0.

In contrast, during the first illumination time period, both the LEDs 220a and the LEDs 220b are on. This allows the backlight 22 to emit light at a higher luminance (the second luminance level b2) of the two luminance levels. During the second illumination time period, only the LEDs 220a are on. This allows the backlight 22 to emit light at a lower luminance (the first luminance level b1) of the two luminance levels.

As a result, an average value of the luminance levels (an average luminance level bm) during the BL illumination period is larger than the first luminance level b1. The average luminance level bm is represented by the following equation:

bm=(Δt12×b2+Δt2n×b1)/Δt1n

where Δt12=t2−t1, Δt2n=tn−t2, and Δt1n=tn−t1

The BL illumination pattern of FIG. 2 is hereinafter referred to as a first BL illumination pattern. According to the first BL illumination pattern, the backlight 22 has a luminance level which varies as below.
In a case where 0≤t<t1 (during the time period before the start of illumination), the backlight 22 has a luminance of 0.
In a case where t1≤t<t2 (during the first illumination time period), the backlight 22 emits light at the second luminance level b2.
In a case where t2≤t<tn (during the second illumination time period), the backlight 22 emits light at the first luminance level b1.
In a case where tn≤t≤16.6 ms (during the time period from the end of illumination), the backlight 22 has a luminance of 0.

According to the first BL illumination pattern, the luminance level decreases stepwise over time in order “from b2 to b1” during the BL illumination period.

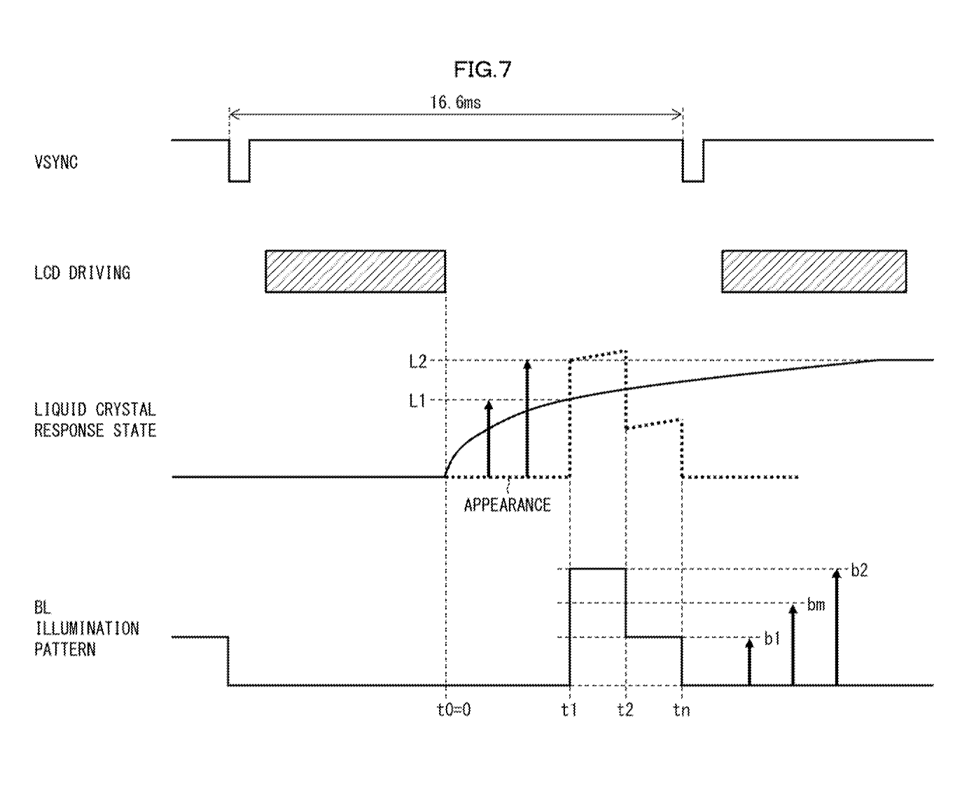

The first BL illumination pattern thus can be defined by the PWM 1 and the PWM 2 which are generated in accordance with the VSYNC. The first BL illumination pattern is an example of a BL illumination pattern which the display device 1 is expected to have (see FIG. 7 (described later)). The BL illumination pattern of FIG. 2 shows an example of how the luminance level decreases stepwise over time during the BL illumination period.

Note that the BL illumination pattern of the display device 1 is not limited to the first BL illumination pattern. It is also possible to define another BL illumination pattern (e.g., a second BL illumination pattern (described later)) by changing a method of switching among values of each of the PWM 1 and the PWM 2 in accordance with an increment in count value. Furthermore, it is possible to define a BL illumination pattern having three or more luminance levels (e.g., a third BL illumination pattern (described later)).

A BL illumination pattern in accordance with an aspect of the present invention only needs to have N luminance levels (light emission intensity levels) that range from the first luminance level (b1) to an Nth luminance level (bN). Note that N is an integer of two or more. Note also that an inequality, b1<b2< . . . <bN is assumed to be satisfied. Specifically, the luminance levels of the BL illumination pattern are numbered in an ascending order. That is, it is assumed that the first luminance level (a first level) is the minimum (lowest) luminance level (light emission intensity level) and the Nth luminance level (an Nth level) is the maximum (highest) luminance level (light emission intensity level). The description of Embodiment 1 takes, as an example, a case where N=2.

### Flow of Process for Setting BL Illumination Pattern

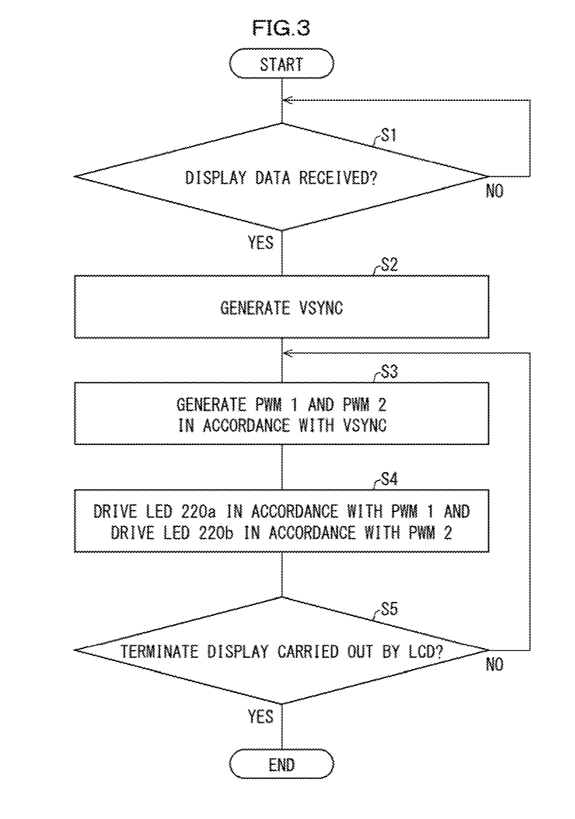

FIG. 3 is a flowchart illustrating a flow of a process including steps S1 through S5 of setting the BL illumination pattern in the display device 1. The steps S1 through S5 can be collectively referred to as a “control step”. First, the LCD driving section 11 determines whether the LCD driving section 11 has received display data (S1). In a case where the LCD driving section 11 receives no display data (NO in S1), the process returns to S1.

The LCD driving section 11 which has received display data (YES in S1) generates the VSYNC in accordance with the display data (S2). The PWM signal generating section 121 receives the VSYNC from the LCD driving section 11 and generates the PWM 1 and the PWM 2 in accordance with the VSYNC (S3). The LCD driving section 11 also generates the LCD driving signal in accordance with the display data. The LCD driving section 11 supplies the VSYNC and the LCD driving signal to the LCD 21 so as to display the display data on the LCD 21.

The backlight power supply 122 receives the PWM 1 and the PWM 2 from the PWM signal generating section 121. The backlight power supply 122 drives the LEDs 220a (first light source group) in accordance with the PWM 1 and drives the LEDs 220b (second light source group) in accordance with the PWM 2 (S4, an illumination control step). For example, as described later, during a time period in which an optical transmittance of the LCD 21 is being changed, the backlight power supply 122 causes the backlight 22 to illuminate in the first BL illumination pattern.

The LCD driving section 11 determines whether to terminate a display carried out by the LCD 21 (S5). In a case where the display carried out by the LCD 21 is not terminated (NO in S5), the process returns to S3. In a case the display carried out by the LCD 21 is terminated, the process for setting the BL illumination pattern is completed.

### Comparative Example 1

The following description discusses Comparative Examples 1 through 3 before discussing effects of the display device 1. Comparative Examples 1 through 3 each show a conventional BL driving method. FIGS. 4 through 6 are views (timing charts) for explaining respective Comparative Examples 1 through 3. Note that a legend “LIQUID CRYSTAL RESPONSE STATE” of, for example, FIG. 4 indicates a change over time in optical transmittance of an LCD 21 (i.e., an optical transmittance of a liquid crystal layer).

The following description discusses Comparative Example 1 first. Comparative Example 1 is an example of a BL driving method referred to as a normal mode (normal driving mode). As shown in FIG. 4, the optical transmittance of the liquid crystal layer transiently increases over time in response to completion of LCD driving. Such a state in which the optical transmittance of the liquid crystal layer transiently increases is hereinafter referred to as “a state in which the liquid crystal layer is in a transient state”. Note that the following description assumes that a point in time at which the LCD driving is completed is t0. Note also that, for convenience, the following description assumes that t0 is a reference time (time 0). The time t0 can also be understood to be a time at which the optical transmittance of the liquid crystal layer starts to change.

According to Comparative Example 1, a backlight is continuously illuminating (is ON). In other words, the backlight continuously has a luminance level that is set so as to be high (have a High value). Thus, a change in state of the liquid crystal layer to the transient state causes a user (viewer of a display surface of the LCD 21) to visually recognize, over time, a continuous change in luminance of the display surface (see Dr1 of FIG. 4). That is, the user recognizes that the liquid crystal layer is in the transient state. As a result, the user who, for example, has caused a moving image to be displayed or has scrolled a screen recognizes the display surface to have an afterimage feeling.

### Comparative Example 2

Comparative Example 2 is an example of a BL driving method referred to as a flash backlight mode. The flash backlight mode is a BL driving method by which to reduce an afterimage feeling that may be produced in the normal mode. The description of Comparative Example 2 takes, as an example, a case (ideal case) where a liquid crystal layer has a sufficiently great response speed (absolute value of a rate of change of an optical transmittance of the liquid crystal layer with respect to time). The response speed of the liquid crystal layer is hereinafter also simply referred to as a “liquid crystal response speed”.

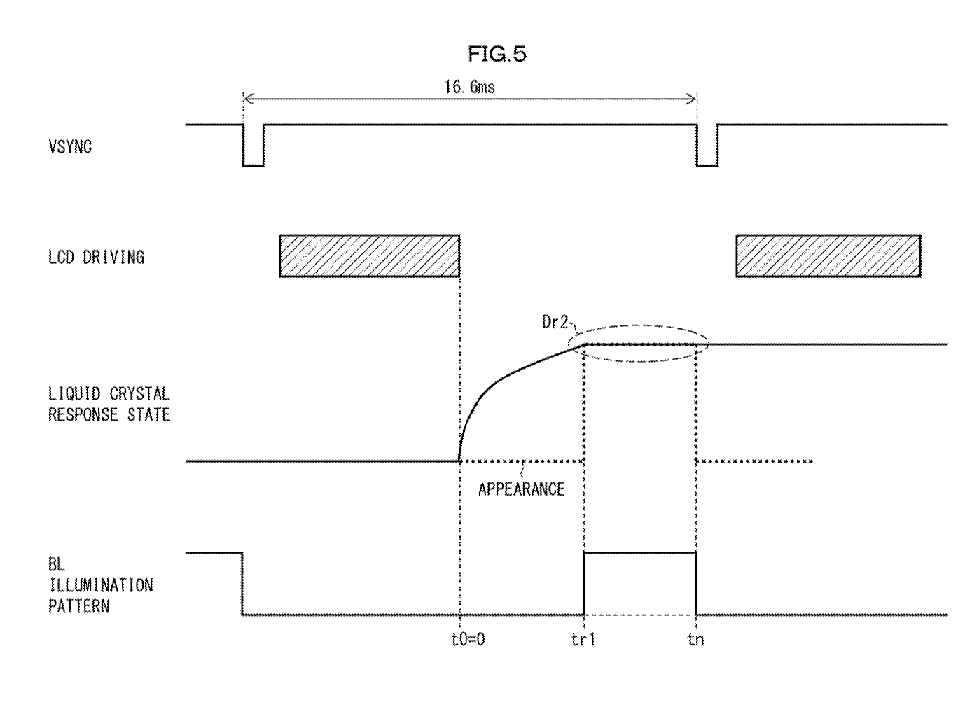

According to the flash backlight mode, a backlight emits pulsed light. Specifically, the backlight is switched (turned) ON/OFF for each predetermined time period. According to the example of FIG. 5, the backlight is switched ON at a point in time at which the optical transmittance of the liquid crystal layer is sufficiently increased and is made substantially constant (i.e., the liquid crystal layer reaches a steady state after getting out of a transient state). According to the example of FIG. 5, a time at which the hack light is switched ON is set as tr1. Then, the backlight is switched OFF at a time tn.

For convenience, the following description assumes that the liquid crystal layer whose optical transmittance has been increased has an optical transmittance of 100% in the steady state. The following description also assumes that the liquid crystal layer has an optical transmittance of 0% at a time t0 (in an initial state). The following description also assumes that a response characteristic of the liquid crystal layer is represented as a first-order lag step response.

In FIG. 5, a legend “APPEARANCE” indicates a luminance of the display surface which is viewed by a user. In other words, the “appearance” is an apparent luminance of the display surface. According to the example of FIG. 5, the backlight is switched ON at a point in time at which the liquid crystal layer reaches the steady state. Thus, the user visually recognizes no continuous change over time in luminance of the display surface at a point in time at which the liquid crystal layer is in the transient state. The user can visually recognize illumination of the display surface only during a BL illumination period from the point in time at which the liquid crystal layer reaches the steady state (see Dr2 of FIG. 5). In a case where the liquid crystal layer thus has a sufficiently high liquid crystal response speed, the afterimage feeling can be suitably reduced by the flash backlight mode.

### Comparative Example 3

Comparative Example 3 is another example of the flash backlight mode. According to an actual liquid crystal panel, a liquid crystal response speed is not necessarily sufficiently high. For example, a liquid crystal response time (a period from a time t0 to a point in time at which a liquid crystal reaches a steady state) may be insufficiently shorter than a time during which a frame of a moving image is being displayed (i.e., 16.6 ms, which is one cycle of a VSYNC). As described above, according to an actual liquid crystal panel, a liquid crystal response speed may be low. Comparative Example 3 shows a problem that may be caused in the flash backlight mode in a case where a liquid crystal response speed is low.

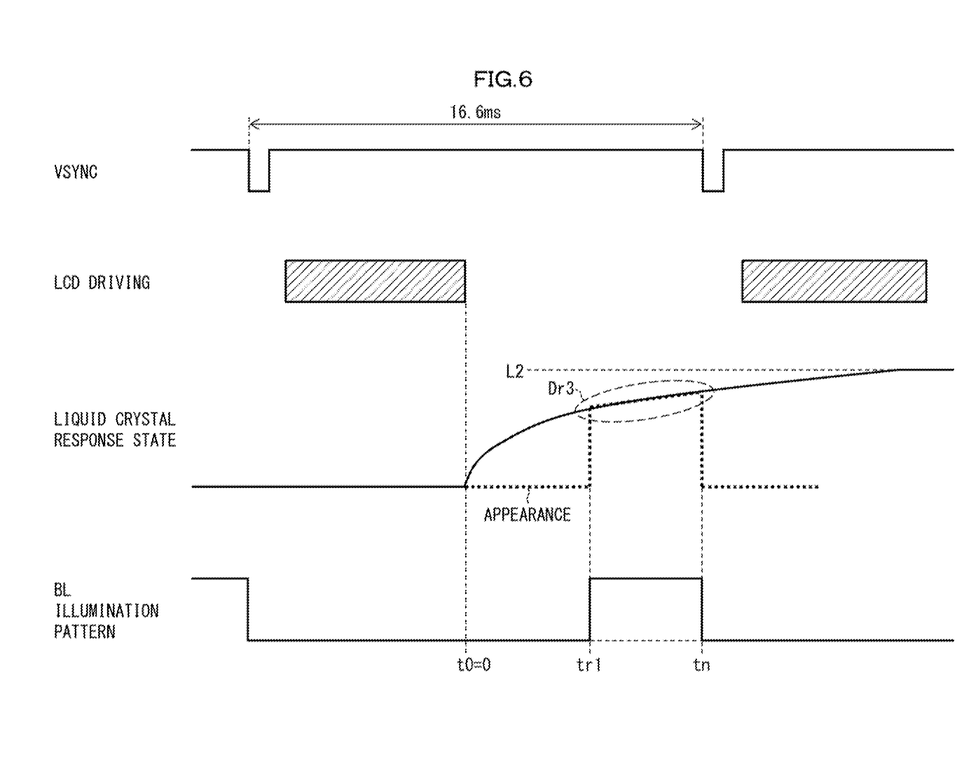

As shown in FIG. 6, in the case where a liquid crystal response speed is low, a backlight is forced to be switched ON before a liquid crystal layer reaches the steady state (while the liquid crystal layer is in a transient state). This is because the backlight needs to illuminate within a time during which a frame of a moving image is being displayed. As a result, also in a case where the backlight is driven by the flash backlight mode, a user visually recognizes a continuous change over time in luminance of a display surface as in the case where the backlight is driven by the normal mode (see Dr3 of FIG. 6).

Specifically, the user visually recognizes a continuous change over time in luminance of the display surface at a point in time at which a luminance level (grayscale level) of the display surface is sufficiently lower than an expected luminance level L2. The luminance level L2 of the example of FIG. 6 is a luminance level of the display surface which luminance level is obtained in a case where the liquid crystal layer has an the optical transmittance of 100% and the backlight is ON.

The inventors of the present application (hereinafter referred to as the inventors) thus newly found the following problem: “In a case where a liquid crystal response speed is low, even the backlight which is driven in the flash backlight mode makes it impossible to achieve an expected luminance level (e.g., prevents the display surface from having a sufficiently high luminance level) at a point in time at which the backlight is turned ON. Thus, the flash backlight mode is insufficient to suitably reduce an afterimage feeling.” The inventors newly attained the display device 1 serving as a specific configuration for solving the above problem.

### First Example

A BL driving method of Embodiment 1 is obtained by further improving the flash backlight mode. Thus, the inventors refer to a BL driving method in accordance with an aspect of the present invention as a quick start (QS) flash backlight mode. As described later, the QS flash backlight mode allows a suitable reduction in afterimage feeling even in a case where a liquid crystal response speed is low.

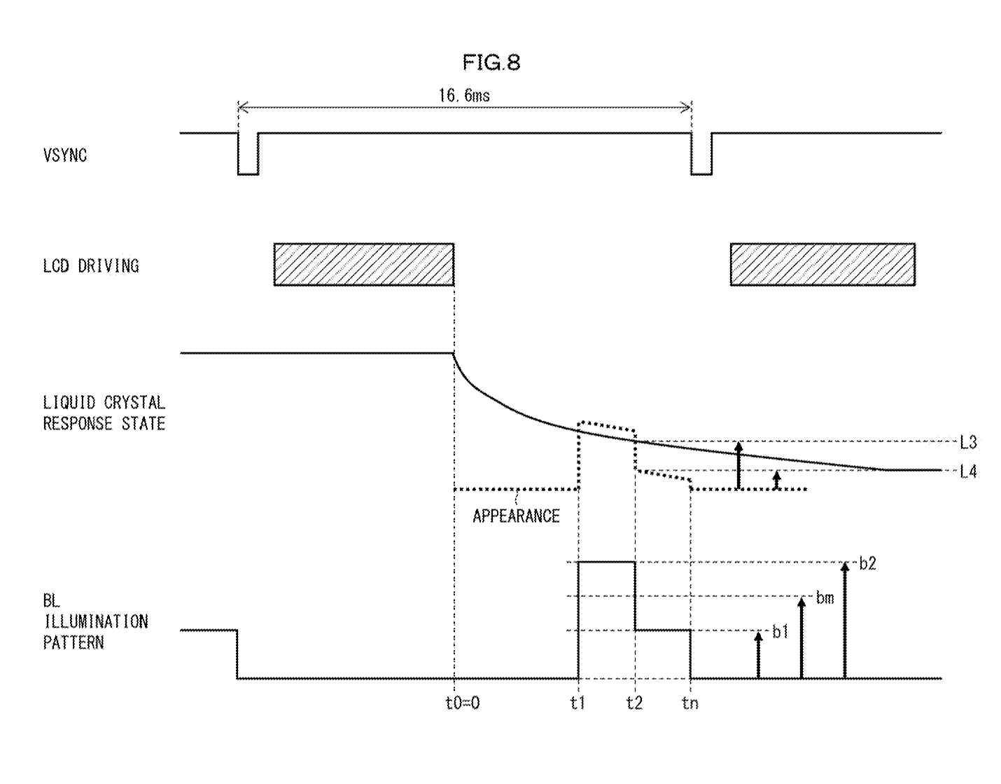

FIG. 7 is a view (timing chart) for explaining a first example of the QS flash backlight mode. FIG. 7 illustrates a case where the first BL illumination pattern is employed as the BL illumination pattern. Note that FIG. 7 illustrates the case of a low liquid crystal response speed as in the case of FIG. 6. Same applies to FIG. 8 and later drawings.

Note that, for convenience, it is assumed in FIG. 7 that the time tn (the point in time at which the BL illumination period ends) coincides with a timing at which the VSYNC of a subsequent frame falls. Specifically, FIG. 7 illustrates a case where no time period from the end of illumination is present in one cycle (16.6 ms) of the VSYNC. Same applies to FIG. 8 and later drawings.

The luminance level L2 (expected luminance level) of the first example is a luminance level of the display surface which luminance level is obtained in a case where the liquid crystal layer reaches a steady state and the backlight 22 is illuminating at the average luminance level bm. Meanwhile, a luminance level L1 (actual grayscale level) is a luminance level of the display surface which luminance level is obtained in a case where the backlight 22 is illuminating at the second luminance level b2 at the time t1. In view of this, ideally, an equation, L2/L1=b2 /bm is preferably satisfied.

The first BL illumination pattern allows the display surface to have a sufficiently high luminance level at the time t1 (see a legend “APPEARANCE” of FIG. 7). More specifically, the first BL illumination pattern makes it possible to provide the user with a luminance level of the display surface which luminance level is close to the luminance level L2. This is because the backlight 22 is illuminating at the second luminance level b2 (a luminance level higher than the average luminance level bm) during the first illumination time period. At and after the time t2, an apparent luminance level increases in accordance with an increase over time in optical transmittance of a liquid crystal.

The first BL illumination pattern thus allows a luminance level substantially equal to the expected luminance level to be obtained at the time t1 (at a point in time at which the backlight 22 is turned ON). Hence, as compared with Comparative Example 3, even a case where the backlight is switched ON while the liquid crystal layer is in a transient state allows a continuous change over time in luminance of the display surface to be less recognizable to the user. In other words, the first BL illumination pattern allows the LCD 21 to have a higher apparent response speed.

Note that a length Δt1n(=tn−t1) of the BL illumination period (i.e., a pulse width in the entire BL illumination pattern) which length is set so as to be shorter allows the afterimage feeling to be more effectively reduced. Note, however, that, in a case where the second luminance level b2 is constant and the length Δt1n is made shorter, the user can visually recognize a lower luminance level. Thus, in order to make the length Δt1n shorter, it is necessary to set a higher second luminance level b2.

Note, however, that in view of a rating of the LEDs 220, it can be said that the second luminance level b2 is preferably set so as not to have a too high value. This is because the LEDs 220 whose light emission intensity is to be increased needs to be supplied with a larger amount; of electric current. This results in generation of a considerable amount of heat from the LEDs 220. In view of this, the length Δt1n is preferably set to approximately 3 ms. Meanwhile, a length Δt12(=t2−t1) of the first illumination time period is preferably set to approximately 1 ms to 1.5 ms.

### Second Example

FIG. 8 is a view (timing chart) for explaining a second example of the QS flash backlight mode. Also in FIG. 8, the first BL illumination pattern is employed as the BL illumination pattern. Note, however, that FIG. 8 illustrates a case where the optical transmittance of the liquid crystal layer is decreased over time. According to the example of FIG. 8, the liquid crystal layer is assumed to have an optical transmittance of 100% at the time t0 (in the initial state). Note, however, that the liquid crystal layer is assumed not to have an optical transmittance of 0% in the steady state.

A luminance level L4 (expected luminance level) of the second example is a luminance level of the display surface which luminance level is obtained in a case where the liquid crystal layer reaches the steady state and the backlight 22 is illuminating at the average luminance level bm. Meanwhile, a luminance level L3 (actual grayscale level) is a luminance level of the display surface which luminance level is obtained in a case where the backlight 22 is illuminating at the first luminance level b1 at the time t2. In view of this, ideally, an equation, L4/L3=b1 /bm is preferably satisfied.

The first BL illumination pattern allows the display surface to have a sufficiently low luminance level at the time t2 (see a legend “APPEARANCE” of FIG. 8). More specifically, the first BL illumination pattern makes it possible to provide the user with a luminance level of the display surface which luminance level is close to the luminance level L4. This is because the backlight 22 is illuminating at the first luminance level b1 (a luminance level lower than the average luminance level bm) during the second illumination time period. At and after the time t2, an apparent luminance level decreases in accordance with a decrease over time in optical transmittance of a liquid crystal.

The first BL illumination pattern thus allows a luminance level substantially equal to the expected luminance level to be obtained at the time t2 (at a point in time at which the luminance level of the backlight 22 is decreased). Thus, as in the case of the first example, the second example allows a continuous change over time in luminance of the display surface to be less recognizable to the user. In other words, the first BL illumination pattern allows the LCD 21 to have a higher apparent response speed.

### Effects

The display device 1 allows the backlight 22 to illuminate, during a time period in which the liquid crystal layer is in the transient state (i.e., during a time period in which the optical transmittance of the liquid crystal layer is being changed), in the BL illumination pattern (e.g., the first BL illumination pattern) having N luminance levels. That is, the backlight 22 can be driven in the QS flash backlight mode. Thus, as described earlier, the QS flash backlight mode makes it possible to more effectively increase an apparent response speed of the LCD 21 than a conventional method (e.g., Comparative Example 3, the flash backlight mode).

Furthermore, unlike the technique of Patent Literature 1, the display device 1 does not require black data to be inserted thereinto. Thus, the display device 1 more effectively allows a reduction in electric power consumption by the display device than the technique of Patent Literature 1. The display device 1 is also suitable for allowing an image display (imaging) to be carried out at a higher speed.

### Variation

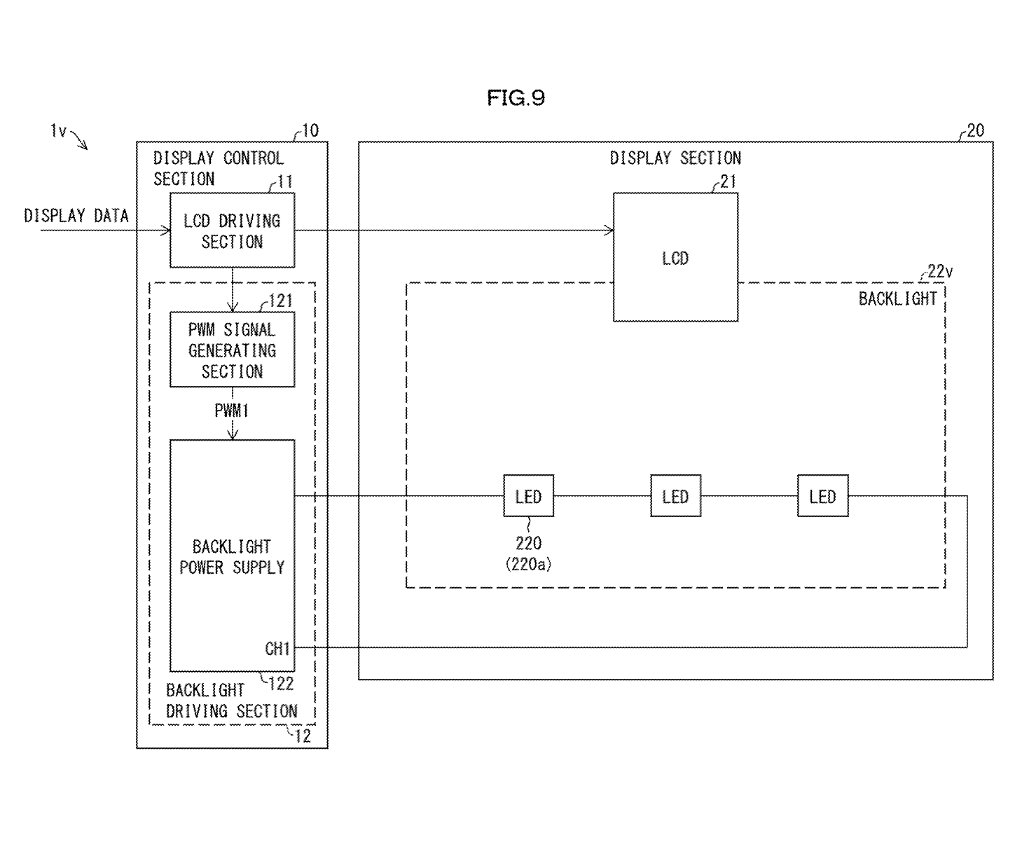

FIG. 9 is a functional block diagram illustrating a configuration of a main part of a display device 1v in accordance with a Variation of the display device 1. The display device 1v includes a backlight which is referred to as a backlight 22v. The backlight 22v is obtained by removing the LEDs 220b (second light source group) from the backlight 22. Unlike the display device 1 of Embodiment 1, the display device 1v allows a first BL illumination pattern to be achieved by using LEDs 220a (a first light source group) alone.

According to the display device 1v, a PWM signal generating section 121 generates, in accordance with a VSYNC, a PWM 1 serving as a tertiary signal. According to the following example, the PWM 1 can have any of three values, which are a Low value (e.g., −1), a Middle value (e.g., 0), and a High value (e.g., 1). The backlight power supply 122 supplies the PWM 1 to each of the LEDs 220a via the CH 1. The backlight power supply 122 drives the LEDs 220a in accordance with the PWM 1.

Specifically, in a case where the PWM 1 has a Low value, the backlight power supply 122 causes the LEDs 220a to be off. In contrast, in a case where the PWM 1 has a Middle value, the backlight power supply 122 causes the LEDs 220a to illuminate at a first light emission intensity (light emission intensity corresponding to the first luminance level b1). Meanwhile, in a case where the PWM 1 has a High value, the backlight power supply 122 causes the LEDs 220a to illuminate at a second light emission intensity (light emission intensity corresponding to the second luminance level b2).

The following description discusses an example of how the PWM 1 is generated in the display device 1v. The PWM signal generating section 121 causes the PWM 1 to switch from Low to High when a count value reaches K. Subsequently, the PWM signal generating section 121 causes the PWM 1 to switch from High to Middle when the count value reaches L. Then, the PWM signal generating section 121 causes the PWM 1 to switch from Middle to Low when the count value reaches M.

By thus causing the LEDs 220a to illuminate at N (e.g., two) light emission intensity levels, it is also possible to achieve a BL illumination pattern having N (e.g., two) light emission intensity levels.

### Embodiment 2

In recent years, a technique has been proposed for providing virtual reality (VR) to a user by use of, for example, a portable display device. In order for the user to experience VR while feeling quite normal, it is effective to prevent or reduce latency in such a display device (e.g., to increase, in response to detection of a body motion of the user, a speed at which to carry out imaging). The display device 1 allows the LCD 21 to have a higher apparent response speed. It follows that the display device 1, which allows imaging to be carried out at a higher speed, is suitably applicable to VR.

For example, it is assumed that Comparative Example 2 (FIG. 5) and the above first example (FIG. 7) are equal in average luminance level. It is also assumed that Comparative Example 2 and the first example are equal in liquid crystal response speed. Note that according to Comparative Example 2, an average luminance level is equal to the maximum luminance level.

According to the display device 1 (QS flash backlight mode), it is possible to turn ON the backlight 22 at the time t1 (i.e., before the liquid crystal layer reaches the steady state) (see FIG. 7). In contrast, according to Comparative Example 2 (the flash backlight mode), in order to prevent or reduce the afterimage feeling, it is necessary to turn ON the backlight at the time tr1 (i.e., at the point in time at which the liquid crystal layer reaches the steady state) (see FIG. 5).

In view of the above, an inequality, t1<tr1 is satisfied. That is, the time t1 is a time earlier than the time tr1. The display device 1 allows achievement of a predetermined luminance level (average luminance level) in a shorter time than a conventional technique. Thus, as compared with a conventional technique, the display device 1 allows imaging to be carried out at a higher speed. The display device 1 is thus suitable as a display device (e.g., smartphone or HMD) for realizing VR (providing VR to the user).

### Embodiment 3

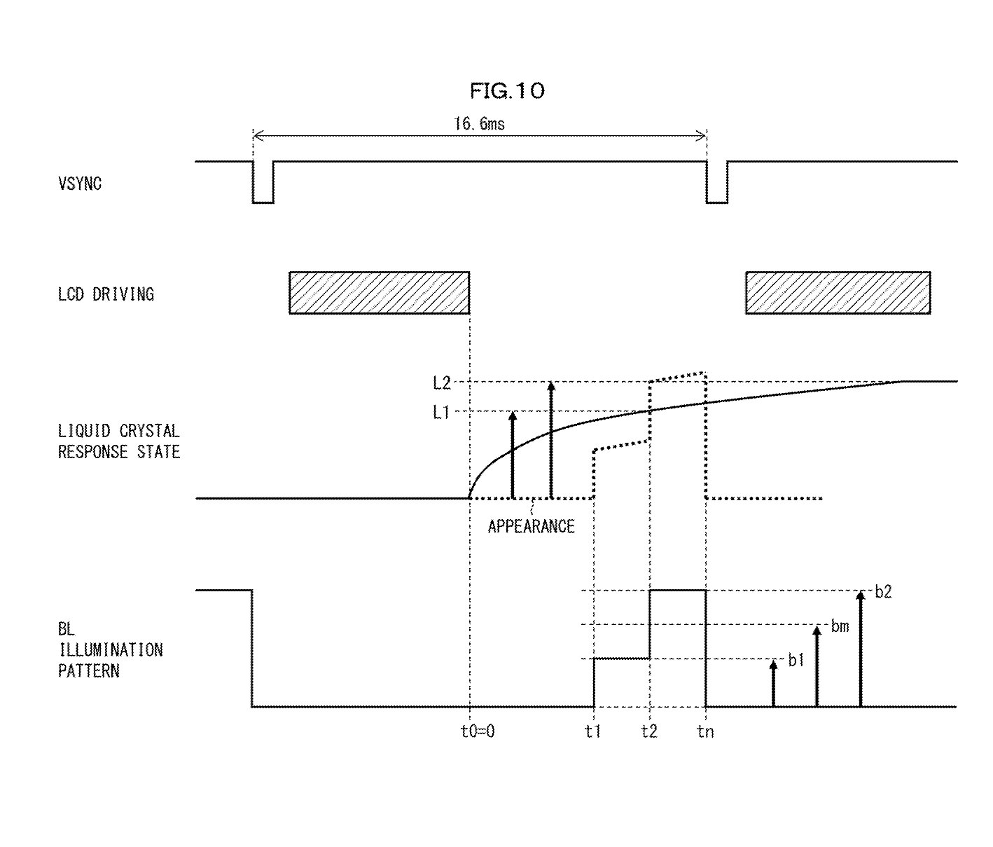

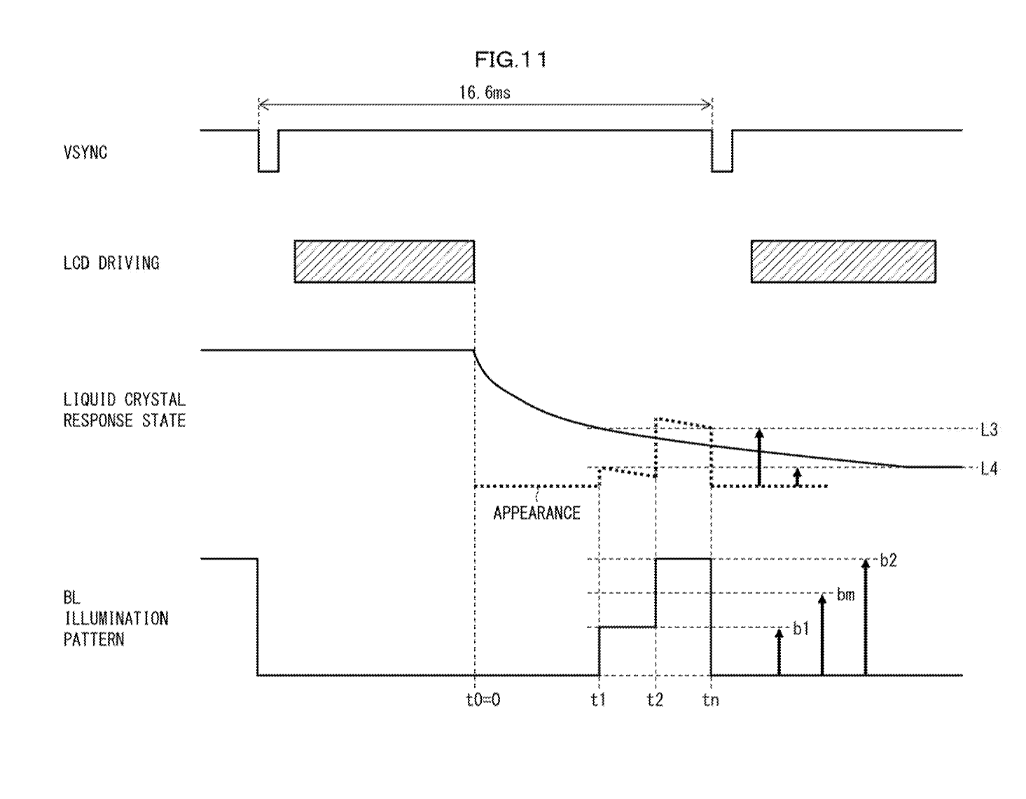

The description of Embodiment 3 takes, as an example, a BL illumination pattern in which a luminance level increases stepwise over time during a BL illumination period (see FIGS. 10 and 11 (described later)). The BL illumination pattern of Embodiment 3 is hereinafter referred to as a second BL illumination pattern.

The second BL illumination pattern can be obtained by arranging the example of FIG. 2 such that (i) in the first illumination time period, the PWM 1 is set to High and the PWM 2 is set to Low and (ii) in the second illumination time period, 69536 37 the PWM 1 is set to High and the PWM 2 is set to High.

According to the second BL illumination pattern, the backlight has a luminance level which varies as below.
In a case where 0≤t<t1 (during the time period before the start of illumination), the backlight has a luminance of 0.
In a case where t1≤t<t2 (during the first illumination time period), the backlight emits light at the first luminance level b1.
In a case where t2≤t<tn (during the second illumination time period), the backlight emits light at the second luminance level b2.
In a case where tn≤t≤16.6 ms (during the time period from the end of illumination), the backlight has a luminance of 0.

According to the second BL illumination pattern, the luminance level increases stepwise over time in order “from b1 to b2” during the BL illumination period.

### Third Example

FIG. 10 is a view (timing chart) for explaining a third example of the QS flash backlight mode. The third example is different from the first example in that the second BL illumination pattern is used in the third example.

According to the third example, the luminance level L1 (actual grayscale level) is a luminance level of the display surface which luminance level is obtained in a case where the backlight 22 is illuminating at the second luminance level b2 at the time t2. Also according to the third example, ideally, an equation, L2/L1=b2/bm is preferably satisfied.

The second BL illumination pattern allows the display surface to have a sufficiently high luminance level at the time t2 (see a legend “APPEARANCE” of FIG. 10). More specifically, the second BL illumination pattern makes it possible to provide the user with a luminance level of the display surface which luminance level is close to the luminance level L2. This is because the backlight 22 is illuminating at the second luminance level b2 (a luminance level higher than the average luminance level bm) during the second illumination time period.

The second BL illumination pattern allows a luminance level substantially equal to the expected luminance level to be obtained at the time t2 (at a point in time at which the luminance level of the backlight 22 reaches the maximum). The second BL illumination pattern thus also allows the LCD 21 to have a higher apparent response speed.

### Fourth Example

FIG. 11 is a view (timing chart) for explaining a fourth example of the QS flash backlight mode. The fourth example is different from the second example in that the second BL illumination pattern is used in the fourth example.

According to the fourth example, the luminance level L3 (actual grayscale level) is a luminance level of the display surface which luminance level is obtained in a case where the backlight 22 is illuminating at the first luminance level b1 at the time t1. Also according to the fourth example, ideally, an equation, L4/L3=b1/bm is preferably satisfied.

The second BL illumination pattern allows the display surface to have a sufficiently low luminance level at the time t1 (see a legend “APPEARANCE” of FIG. 11). More specifically, the second BL illumination pattern makes it possible to provide the user with a luminance level of the display surface which luminance level is close to the luminance level L4. This is because the backlight 22 is illuminating at the first luminance level b1 (a luminance level lower than the average luminance level bm) during the first illumination time period.

The second BL illumination pattern allows a luminance level substantially equal to the expected luminance level to be obtained at the time t1 (at the point in time at which the backlight 22 is turned ON). The second BL illumination pattern thus also allows the LCD 21 to have a higher apparent response speed.

### Embodiment 4

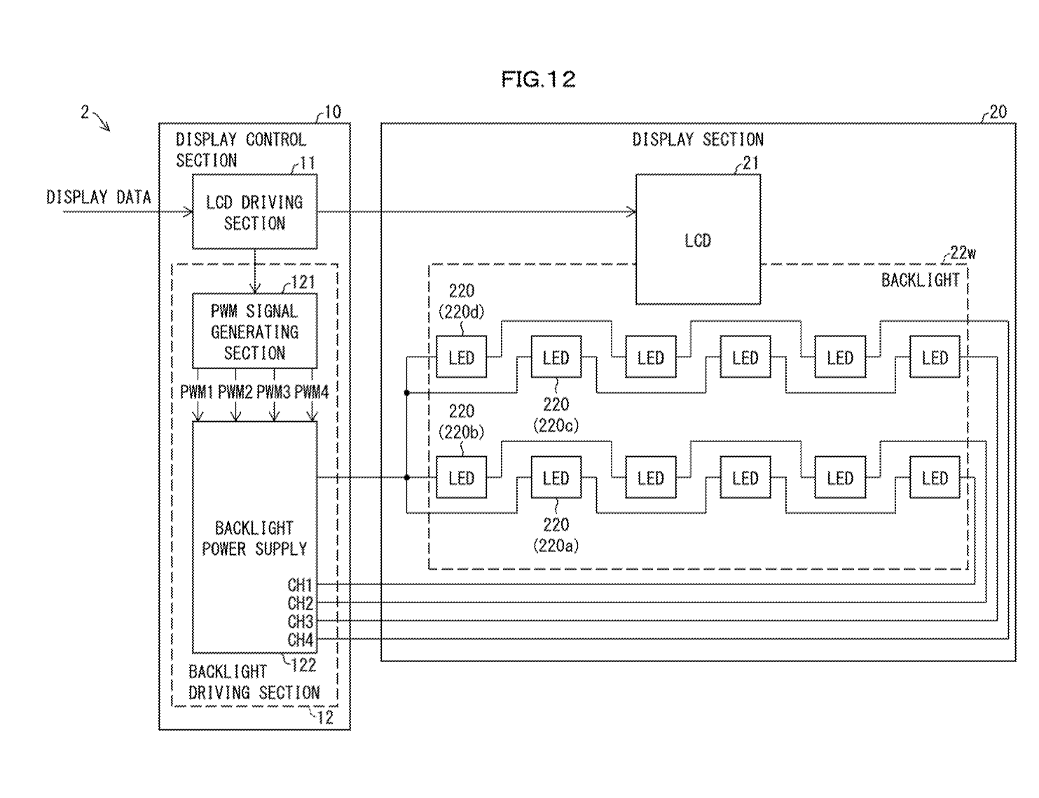

FIG. 12 is a functional block diagram illustrating a configuration of a main part of a display device 2 of Embodiment 4. The display device 2 includes a backlight which is referred to as a backlight 22w. The backlight 22w is obtained by causing the backlight 22 to further include LEDs 220c (a third light source group) and LEDs 220d (a fourth light source group).

A group of LEDs 220a through a group of LEDs 220d are each connected in parallel with a backlight power supply 122. The group of LEDs 220a through the group of LEDs 220d can be driven independently of each other. The group of LEDs 220c is connected to a CH 3 (third channel) of the backlight power supply 122, and the group of LEDs 220d is connected to a CH 4 (fourth channel) of the backlight power supply 122. As in the case of the group of LEDs 220a and the group of LEDs 220b, the group of LEDs 220c and the group of LEDs 220d are provided so as to separately allow the backlight 22w to uniformly illuminate.

According to the display device 2, a PWM signal generating section 121 generates a PWM 1 through a PWM 4 in accordance with a VSYNC. In Embodiment 4, the PWM 1 through the PWM 4 are each used as a light source control signal. A PWM 3 (third PWM signal) and a PWM 4 (fourth PWM signal) are generated as in the case of the generation of the PWM 1 and the PWM 2 of Embodiment 1.

The backlight power supply 122 supplies the PWM 3 to the LEDs 220c via the CH 3. The backlight power supply 122 drives the LEDs 220c in accordance with the PWM 3. The backlight power supply 122 supplies the PWM 4 to the LEDs 220d via the CH 4. The backlight power supply 122 drives the LEDs 220d in accordance with the PWM 4. The LEDs 220c and the LEDs 220d are driven as in the case of the driving of the LEDs 220a and the LEDs 220b of Embodiment 1.

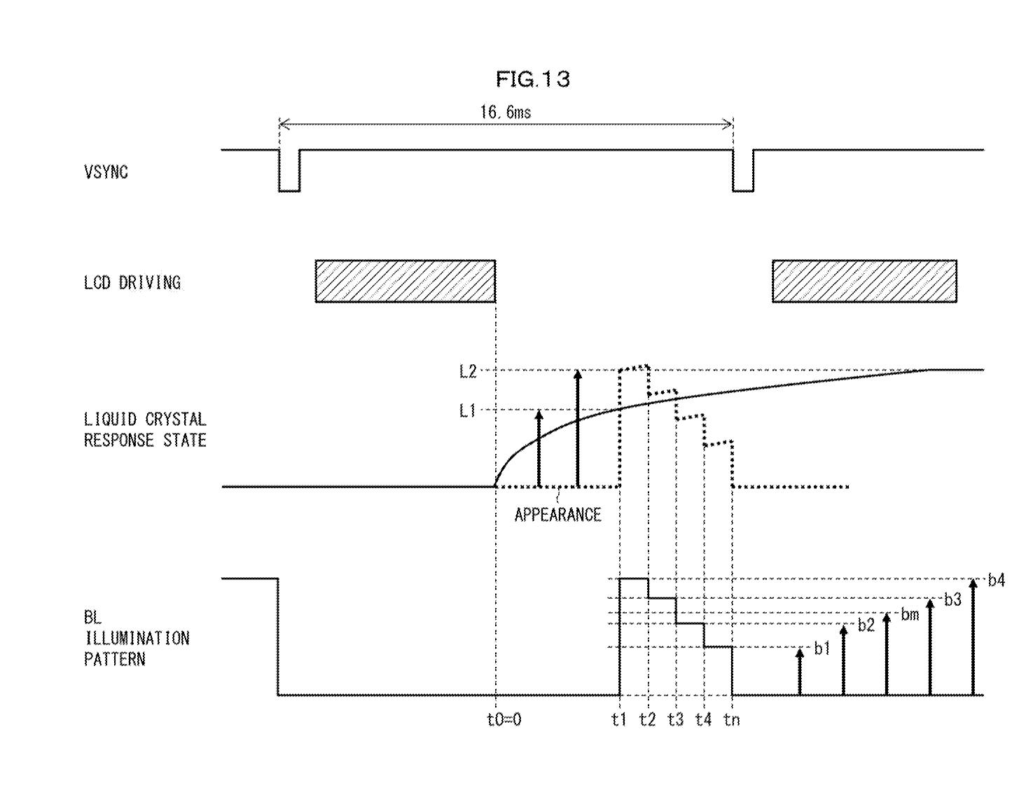

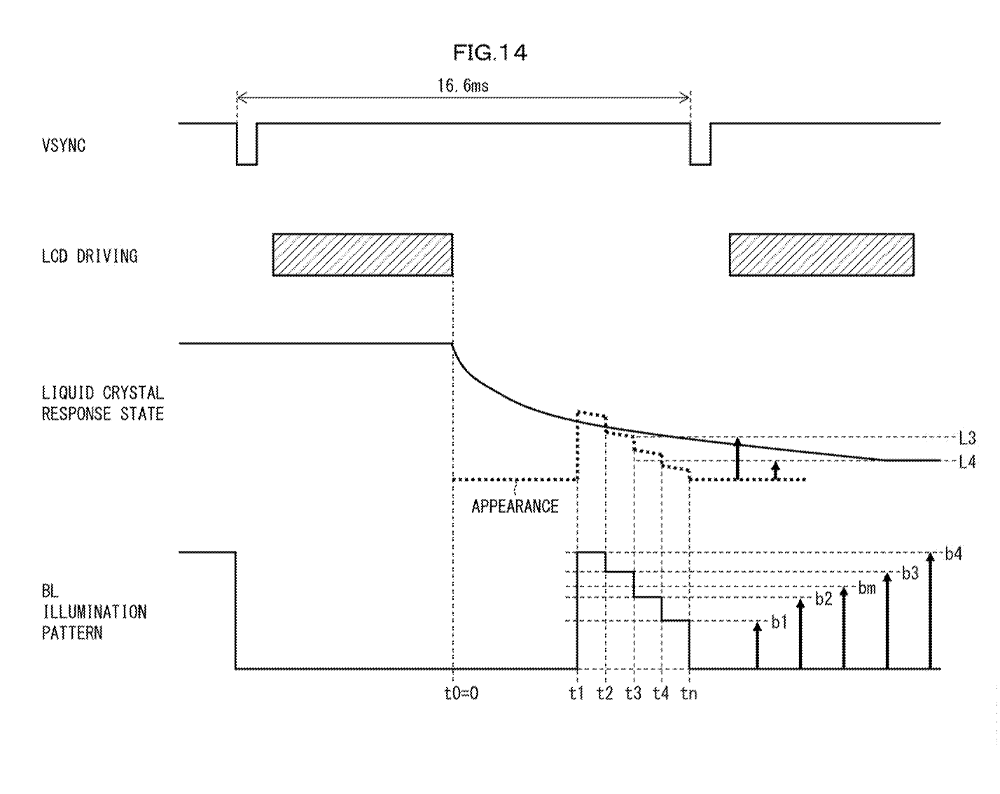

The description of Embodiment 4 takes, as an example, a BL illumination pattern having four luminance levels that range from a first luminance level b1 to a fourth luminance level b4 (see FIGS. 13 and 14 (described later)). The BL illumination pattern of Embodiment 4 is hereinafter referred to as a third BL illumination pattern. According to the PWM 1 through PWM 4, it is possible to achieve the third BL illumination pattern as below.

According to the third BL illumination pattern, the backlight 22w has a luminance level which varies as below.
In a case where 0≤t<t1 (during a time period before the start of illumination), the backlight 22w has a luminance of 0.
In a case where t1≤t<t2 (during a first illumination time period), the backlight 22w emits light at the fourth luminance level b4.
In a case where t2≤t<t3 (during a second illumination time period), the backlight 22w emits light at the third luminance level b3.
In a case where t3≤t<t4 (during a third illumination time period), the backlight 22w emits light at the second luminance level b2.
In a case where t4≤t<tn (during a fourth illumination time period), the backlight 22w emits light at the first luminance level b1.
In a case where tn≤t≤16.6 ms (during a time period from the end of illumination), the backlight 22w has a luminance of 0.

According to the third BL illumination pattern, the luminance level decreases stepwise over time in an order of “b4, b3, b2, and b1”. Embodiment 4 collectively refers to the first illumination time period to the fourth illumination time period as a BL illumination period. Note that a time t1 is a point in time at which the BL illumination period starts, and a time tn is a point in time at which the BL illumination period ends.

The fourth luminance level b4 is a luminance level which is obtained in a case where the group of LEDs 220a through the group of LEDs 220d (all the four light source groups) illuminate. The third luminance level b3 is a luminance level which is obtained in a case where the group of LEDs 220a through the group of LEDs 220c (three of the four light source groups) illuminate.

Assuming that Δt23=t3−t2, Δt34=t4−t3, and Δt4n=tn−t4, the average luminance level bm of Embodiment 4 is represented by the following equation:

bm=(AA4+AA3+AA2+AA1)/Δt1n

where AA4=Δt12×b4, AA3=Δt23×b3, AA2=Δt34 ×b2, and AA1=Δt4n×b1

According to Embodiment 4, Δt12(=t2−t1) preferably falls within the range of approximately 0.5 ms to 0.8 ms. Note that Embodiment 4 assumes that Δt13=t3−t1 and Δt14=t4−t1. It is preferred that Δt13 fall within the range of approximately 1 ms to 1.5 ms and Δt14 fall within the range of approximately 2 ms to 2.5 ms. Also according to Embodiment 4, Δt1n is preferably approximately 3 ms.

### Fifth Example

FIG. 13 is a view (timing chart) for explaining a fifth example of the QS flash backlight mode. The fifth example is different from the first example in that the third BL illumination pattern is used in the fifth example.

According to the fifth example, the luminance level L1 (actual grayscale level) is a luminance level of the display surface which luminance level is obtained in a case where the backlight 22w is illuminating at the fourth luminance level b4 at the time t1. According to the fourth example, ideally, an equation, L2/L1=b4/bm is preferably satisfied.

The third BL illumination pattern allows the display surface to have a sufficiently high luminance level at the time t1 (see a legend “APPEARANCE” of FIG. 13). This is because the backlight 22w is illuminating at the fourth luminance level b4 (a luminance level higher than the average luminance level bm) during the first illumination time period. The third BL illumination pattern also allows the LCD 21 to have a higher apparent response speed.

### Sixth Example

FIG. 14 is a view (timing chart) for explaining a sixth example of the QS flash backlight mode. The sixth example is different from the second example in that the third BL illumination pattern is used in the sixth example.

According to the sixth example, the luminance level L3 (actual grayscale level) is a luminance level of the display surface which luminance level is obtained in a case where the backlight 22w is illuminating at the first luminance level b1 at the time t4. Also according to the sixth example, ideally, an equation, L4/L3=b1/bm is preferably satisfied.

The third BL illumination pattern allows the display surface to have a sufficiently low luminance level at the time t4 (see a legend “APPEARANCE” of FIG. 14). This is because the backlight 22w is illuminating at the first luminance level b1 (a luminance level lower than the average luminance level bm) during the fourth illumination time period.

The third BL illumination pattern allows a luminance level substantially equal to the expected luminance level to be obtained at the time t1 (at a point in time at which the backlight 22w is turned ON). The third BL illumination pattern thus also allows the LCD 21 to have a higher apparent response speed.

### Supplemental Remarks

As described earlier, the BL illumination pattern having N luminance levels can be achieved by classifying the light sources (LEDs 220) into N light source groups that range from a first light source group to an Nth light source group. Assume here that the N light source groups are each provided so as to allow the backlight to uniformly illuminate.

A Kth light source group (K is an integer satisfying an inequality, 1≤K≤N) is connected to a CH K (Kth channel) of the backlight power supply 122. Specifically, the N light source groups are each connected in parallel with the backlight power supply 122. It follows that the N light source groups can be driven independently of each other. The backlight power supply 122 supplies a PWM K (Kth PWM signal) to the Kth light source group via the CH K. The Kth light source group is driven in accordance with the PWM K.

According to the above configuration, the first luminance level b1 (the lowest luminance level of the N levels) is a luminance level of the backlight which luminance level is obtained in a case where only a predetermined one (e.g., the first light source group) of the N light source groups is turned on. Assume, for example, that the N light source groups are equal in light emission intensity. In this case, any one of the light source groups can be selected as the predetermined light source group. In contrast, in a case where the N light source groups are different in light emission intensity, a light source group having the lowest light emission intensity can be selected as the predetermined light source group.

The Nth luminance level bN (the highest luminance level of the N levels) is a luminance level of the backlight which luminance level is obtained in a case where all the N light source groups (all the light source groups that range from the first light source group to the Nth light source group) are turned on.

### Variation

The display device 1 of Embodiment 1 also makes it possible to provide the third BL illumination pattern. As in the case of the display device 1v, the display device 1 of Embodiment 1 makes it possible to provide the third BL illumination pattern (BL illumination pattern having four light emission intensity levels) by causing each of the group of LEDs 220a and the group of LEDs 220b to illuminate at two light emission intensity levels.

### Software Implementation Example

Control blocks of the display device 1, 1v, or 2 (particularly, the display control section 10) can be realized by a logic circuit (hardware) provided in an integrated circuit (IC chip) or the like or can be alternatively realized by software.

In the latter case, the display device 1, 1v, or 2 includes a computer that executes instructions of a program that is software realizing the foregoing functions. This computer includes not only at least one processor (control device), for example but also at least one computer-readable storage medium in which the program is stored. An object of an aspect of the present invention can be achieved by the processor of the computer which processor reads and executes the program stored in the storage medium. The processor can be, for example, a central processing unit (CPU). Examples of the storage medium encompass not only a read only memory (ROM), for example but also “a non-transitory tangible medium” such as a tape, a disk, a card, a semiconductor memory, and a programmable logic circuit. The display device can further include, for example, a random access memory (RAM) in which the above program is loaded. The program can be supplied to or made available to the computer via any transmission medium (such as a communication network or a broadcast wave) which allows the program to be transmitted. Note that an aspect of the present invention can also be achieved in the form of a data signal in which the program is embodied via electronic transmission and which is embedded in a carrier wave.

### Recap

A display device (1) in accordance with a first aspect of the present invention includes: a liquid crystal panel (LCD 21); a backlight (22); and a control device (display control section 10) configured to control the liquid crystal panel and the backlight, the control device causing the backlight to illuminate, during a time period in which an optical transmittance of the liquid crystal panel is being changed, in an illumination pattern (BL illumination pattern) having N (N is an integer of two or more) light emission intensity levels (e.g., luminance levels) that range from a first level (e.g., a first luminance level b1) to an Nth level (e.g., an Nth luminance level bN).

The configuration allows the backlight to be driven in the QS flash backlight mode (described earlier). Hence, unlike a conventional flash backlight mode, the QS flash backlight mode allows an increase in apparent response speed of even a liquid crystal panel which has a low response speed. Specifically, the QS flash backlight mode more effectively allows an increase in apparent response speed of a liquid crystal panel than the conventional flash backlight mode.

In a second aspect of the present invention, a display device can be configured such that: in the first aspect, the backlight includes a plurality of light sources (LEDs 220) which is provided so as to cause the backlight to uniformly illuminate; the control device generates a light source control signal (e.g., a PWM 1 and a PWM 2) for controlling the plurality of light sources in accordance with a liquid crystal panel control signal (e.g., a VSYNC) for controlling a display timing of the liquid crystal panel; and the control device turns on the plurality of light sources in accordance with the light source control signal so as to cause the backlight to illuminate in the illumination pattern.

The configuration makes it possible to define the BL illumination pattern in accordance with the liquid crystal panel control signal.

In a third aspect of the present invention, a display device can be configured such that; in the second aspect, the plurality of light sources is classified into N light source groups that range from a first light source group (e.g., LEDs 220a) to an Nth light source group (e.g., a second Light source group, LEDs 220b) and are provided so as to cause the backlight to uniformly illuminate; and assuming that the first level is the lowest light emission intensity level of N light emission intensity levels and the Nth level is the highest light emission intensity level of the N light emission intensity levels, the first level is a light emission intensity level of the backlight which light emission intensity level is obtained in a case where only one predetermined light source group of the N light source groups illuminates, and the Nth level is a light emission intensity level of the backlight which light emission intensity level is obtained in a case where all the N light source groups illuminate.

The configuration makes it possible to achieve the BL illumination pattern by providing the N light source groups.

In a fourth aspect of the present invention, a display device can be configured such that, in any one of the first through third aspects, the illumination pattern is a pattern in which a light emission intensity level decreases stepwise over time.

The configuration allows a stepwise decrease in light emission intensity level in accordance with an increase or a decrease in optical transmittance of the liquid crystal panel (see, for example, FIGS. 7 and 8). This allows the liquid crystal panel to have a higher apparent response speed.

In a fifth aspect of the present invention, a display device can be configured such that, in any one of the first through third aspects, the illumination pattern is a pattern in which a light emission intensity level increases stepwise over time.

The configuration allows a stepwise increase in light emission intensity level in accordance with an increase or a decrease in optical transmittance of the liquid crystal panel (see, for example, FIGS. 10 and 11). This allows the liquid crystal panel to have a higher apparent response speed.

A method in accordance with a sixth aspect of the present invention for controlling a display device including a liquid crystal panel and a backlight, the method includes: a control step of controlling the liquid crystal panel and the backlight, the control step further including an illumination control step of causing the backlight to illuminate, during a time period in which an optical transmittance of the liquid crystal panel is being changed, in an illumination pattern having N (N is an integer of two or more) light emission intensity levels that range from a first level to an Nth level.

### Additional Remarks

An aspect of the present invention is not limited to the above embodiments, but can be altered by a person skilled in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### Reference Signs List

1, 1v, 2 Display device
10 Display control section (control device)
11 LCD driving section
12 Backlight driving section
20 Display section
21 LCD (liquid crystal panel)
22, 22v, 22w Backlight
121 PWM signal generating section
122 Backlight power supply
220 LED (light source)
220a LED (first light source group)
220b LED (second light source group, Nth light source group)
220d LED (fourth light source group, Nth light source group)
b1 First luminance level (first level)
b2 Second luminance level (second level, Nth level)
b4 Fourth luminance level (fourth level, Nth level)
bN Nth luminance level (Nth level)
bm Average luminance level
VSYNC Vertical synchronization signal (liquid crystal panel control signal)
PWM 1 to PWM 4 Light source control signal

1. A display device comprising:
a liquid crystal panel;
a backlight; and
a control device configured to control the liquid crystal panel and the backlight,
the control device causing the backlight to illuminate, during a time period in which an optical transmittance of the liquid crystal panel is being changed, in an illumination pattern having N (N is an integer of two or more) light emission intensity levels that range from a first level to an Nth level.

2. The display device as set forth in claim 1, wherein:
the backlight includes a plurality of light sources which is provided so as to cause the backlight to uniformly illuminate;
the control device generates a light source control signal for controlling the plurality of light sources in accordance with a liquid crystal panel control signal for controlling a display timing of the liquid crystal panel; and
the control device turns on the plurality of light sources in accordance with the light source control signal so as to cause the backlight to illuminate in the illumination pattern.

3. The display device as set forth in claim 2, wherein:
the plurality of light sources is classified into N light source groups that range from a first light source group to an Nth light source group and are provided so as to cause the backlight to uniformly illuminate; and
assuming that the first level is the lowest light emission intensity level of N light emission intensity levels and the Nth level is the highest light emission intensity level of the N light emission intensity levels,
the first level is a light emission intensity level of the backlight which light emission intensity level is obtained in a case where only one predetermined light source group of the N light source groups illuminates, and
the Nth level is a light emission intensity level of the backlight which light emission intensity level is obtained in a case where all the N light source groups illuminate.

4. The display device as set forth in claim 1, wherein the illumination pattern is a pattern in which a light emission intensity level decreases stepwise over time.

5. The display device as set forth in claim 1, wherein the illumination pattern is a pattern in which a light emission intensity level increases stepwise over time.

6. A method for controlling a display device including a liquid crystal panel and a backlight,
said method comprising:
a control step of controlling the liquid crystal panel and the backlight,
the control step further including an illumination control step of causing the backlight to illuminate, during a time period in which an optical transmittance of the liquid crystal panel is being changed, in an illumination pattern having N (N is an integer of two or more) light emission intensity levels that range from a first level to an Nth level.
